(19) United States
(12) Patent Application Publication
(10) Pub. No.: US 2024/0346736 A1
(43) Pub. Date: Oct. 17, 2024

(54) INFORMATION PROCESSING DEVICE, INFORMATION PROCESSING METHOD, AND PROGRAM

(71) Applicant: Sony Group Corporation, Tokyo (JP)

(72) Inventors: Seiji SUZUKI, Kanagawa (JP); Yo NONOYAMA, Kanagawa (JP)

(73) Assignee: Sony Group Corporation, Tokyo (JP)

(21) Appl. No.: 18/683,253

(22) PCT Filed: Mar. 7, 2022
(86) PCT No.: PCT/JP2022/009611

§ 371 Date: Feb. 13, 2024

(30) Foreign Application Priority Data
Aug. 26, 2021 (JP) 2021-137698

(51) Int. Cl. G06T 13/40; G06T 5/50; G06T 17/00

(52) U.S. Cl. CPC G06T 13/40; G06T 5/50; G06T 17/00; G06T 2207/20044; G06T 2207/20221

(57) ABSTRACT

There is provided an information processing device, an information processing method, and a program which enable more appropriate visualization of an exercise. A three-dimensional shape generation unit generates three-dimensional shape data representing a three-dimensional shape of a user on the basis of a depth image and an RGB image, and a skeleton detection unit generates skeleton data representing a skeleton of the user on the basis of the depth image. Then, the visualization information for visualizing the exercise of the user is generated using the three-dimensional shape data and the skeleton data, and the exercise visualization image is generated by arranging and capturing the visualization information on the three-dimensional shape of the user reconstructed in the virtual three-dimensional space on the basis of the three-dimensional shape data. The present technology can be applied to, for example, an exercise visualization system that supports training of a user.

### TECHNICAL FIELD

The present disclosure relates to an information processing device, an information processing method, and a program, and more particularly, to an information processing device, an information processing method, and a program which enable more appropriate visualization of an exercise.

### BACKGROUND ART

Conventionally, it has been proposed to support training by recognizing motions of a user who performs various exercises and performing feedback on the exercises of the user.

For example, Patent Document 1 discloses a method for generating animation data modeling a feature of a surface of a user in a motion picture for capturing and recognizing a motion of the user or an object.

### CITATION LIST

### Patent Document

Patent Document 1: Japanese Unexamined Patent Application Publication No. 2010-508609

### SUMMARY OF THE INVENTION

### Problems to be Solved by the Invention

By the way, there is a demand for visualization of an exercise such that training support can be appropriately performed in accordance with the exercise performed by a user.

The present disclosure has been made in view of such circumstances, and enables more appropriate visualization of an exercise.

### Solutions to Problems

An information processing device according to one aspect of the present disclosure includes: a three-dimensional shape generation unit that generates three-dimensional shape data representing a three-dimensional shape of a user on the basis of a depth image and an RGB image; a skeleton detection unit that generates skeleton data representing a skeleton of the user on the basis of the depth image; and a visualization information generation unit that generates visualization information for visualizing an exercise of the user using the three-dimensional shape data and the skeleton data, and arranges and captures the visualization information on the three-dimensional shape of the user reconstructed in a virtual three-dimensional space on the basis of the three-dimensional shape data to generate an exercise visualization image.

An information processing method or a program according to one aspect of the present disclosure includes: generating three-dimensional shape data representing a three-dimensional shape of a user on the basis of a depth image and an RGB image; generating skeleton data representing a skeleton of the user on the basis of the depth image; and generating visualization information for visualizing an exercise of the user using the three-dimensional shape data and the skeleton data, and arranging and capturing the visualization information on the three-dimensional shape of the user reconstructed in a virtual three-dimensional space on the basis of the three-dimensional shape data to generate an exercise visualization image.

In one aspect of the present disclosure, the three-dimensional shape data representing the three-dimensional shape of the user is generated on the basis of the depth image and the RGB image, and the skeleton data representing the skeleton of the user is generated on the basis of the depth image. Then, the visualization information for visualizing the exercise of the user is generated using the three-dimensional shape data and the skeleton data, and the exercise visualization image is generated by arranging and capturing the visualization information on the three-dimensional shape of the user reconstructed in the virtual three-dimensional space on the basis of the three-dimensional shape data.

### BRIEF DESCRIPTION OF DRAWINGS

FIG. 1 is a view illustrating a configuration example of an embodiment of an exercise visualization system to which the present technology is applied.

FIG. 2 is a view illustrating a display example of a UI screen in a normal display mode.

FIG. 3 is a view illustrating a display example of a UI screen in a joint information visualization display mode.

FIG. 4 is a view illustrating examples of visualization in the joint information visualization display mode.

FIG. 5 is a view illustrating a display example of a UI screen in a time-series information visualization display mode.

FIG. 6 is a view illustrating examples of visualization in the time-series information visualization display mode.

FIG. 7 is a view illustrating a display example of a UI screen in an overlay visualization display mode.

FIG. 8 is a view illustrating a display example of a UI screen in an exaggeration effect visualization display mode.

FIG. 9 is a view illustrating examples of visualization in the exaggeration effect visualization display mode.

FIG. 10 is a block diagram illustrating a configuration example of the exercise visualization system.

FIG. 11 is a flowchart for describing exercise visualization processing.

FIG. 12 is a flowchart for describing display processing of the UI screen in the joint information visualization display mode.

FIG. 13 is a view for describing generation of joint information.

FIG. 14 is a flowchart for describing display processing of the UI screen in the overlay visualization display mode.

FIG. 15 is a view for describing determination of a color arrangement based on a deviation amount.

FIG. 16 is a flowchart illustrating display mode switching processing.

FIG. 17 is a view for describing movement of a virtual camera.

FIG. 18 is a view illustrating a configuration example of a remote system using the exercise visualization system.

FIG. 19 is a view illustrating coaching of training in the remote system.

FIG. 20 is a view for describing processing executed in the remote system.

FIG. 21 is a view illustrating a configuration example of an exercise visualization system including a projector.

FIG. 22 is a view for describing a use example in which projection onto wall surfaces is performed.

FIG. 23 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

### <Configuration Example of Exercise Visualization System>

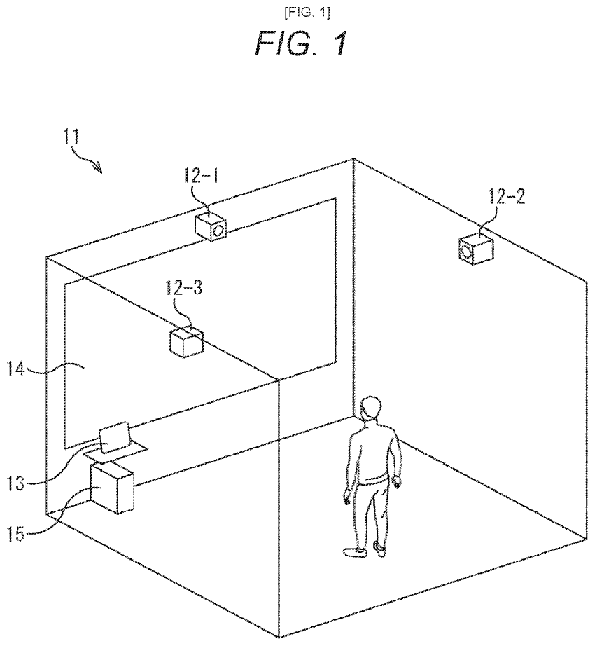

FIG. 1 is a view illustrating a configuration example of an embodiment of an exercise visualization system to which the present technology is applied.

An exercise visualization system 11 is used to support training of a user by sensing motions of the user performing various exercises and displaying an image (hereinafter, referred to as an exercise visualization image) visualizing a corresponding exercise. In this manner, in order to sense the motions of the user, the exercise visualization system 11 is installed in a training room having a length of about 3 m on one side, for example.

As illustrated in FIG. 1, the exercise visualization system 11 includes three sensor units 12-1 to 12-3, a tablet terminal 13, a display device 14, and an information processing device 15.

The sensor unit 12-1 is arranged in the vicinity of an upper side of a front wall of the training room, the sensor unit 12-2 is arranged in the vicinity of an upper side of a right side wall of the training room, and the sensor unit 12-3 is arranged in the vicinity of an upper side of a left side wall of the training room. Then, the sensor units 12-1 to 12-3 output images obtained by sensing the user exercising in the training room from the respective positions, for example, depth images and RGB images as described later. Note that the number of the sensor units 12 provided in the exercise visualization system 11 may be three or less or more, and the sensor units 12 are not limited to arrangement positions in the illustrated arrangement example, and may be arranged on a back wall, a ceiling, or the like.

The tablet terminal 13 displays a UI screen in which UI parts and the like to be used by the user to input an operation with respect to the exercise visualization system 11 are superimposed on the exercise visualization image visualizing the exercise of the user.

The display device 14 includes a large screen display installed so as to cover most of the front wall of the training room, a projector capable of projecting a video on most of the large screen display, and the like, and displays the exercise visualization image in linkage with the tablet terminal 13.

The information processing device 15 recognizes a three-dimensional shape (volumetric) and a skeleton (bone) of the user and recognizes equipment used by the user on the basis of the depth images and the RGB images output from the sensor units 12-1 to 12-3. Then, the information processing device 15 converts the three-dimensional shapes of the user and the equipment into three-dimensional digital data, and reconstructs the three-dimensional shapes of the user and the equipment in a virtual three-dimensional space. Moreover, the information processing device 15 generates visualization information (for example, a numerical value, a graph, and the like) for visualizing the exercise of the user on the basis of the three-dimensional shape and the skeleton of the user. Then, the information processing device 15 arranges the visualization information at an appropriate position in the virtual three-dimensional space in which the three-dimensional shapes of the user and the equipment are reconstructed, and captures an image by a virtual camera set in an appropriate arrangement for each display mode as described later to generate the exercise visualization image.

The exercise visualization system 11 is configured in this manner, and the user can perform the exercise while viewing the exercise visualization image displayed on the display device 14.

Furthermore, a plurality of display modes is prepared in the exercise visualization system 11, and the user can switch the display mode using the UI screen displayed on the tablet terminal 13. For example, the display modes of the exercise visualization system 11 include a normal display mode, a joint information visualization display mode, a time-series information visualization display mode, an overlay visualization display mode, and an exaggeration effect visualization display mode.

### <Display Example of UI Screen in Each Display Mode>

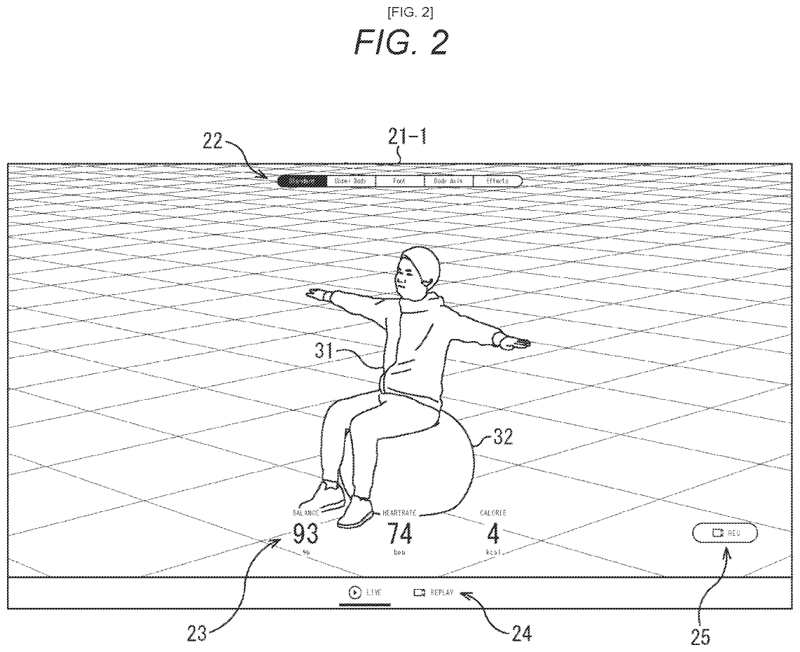

A display example of the UI screen in each of the display modes of the exercise visualization system 11 will be described with reference to FIGS. 2 to 9.

FIG. 2 is a view illustrating an example of a UI screen 21-1 displayed on the tablet terminal 13 in the normal display mode.

On the UI screen 21-1 in the normal display mode, a display mode switching tab 22, a status display section 23, a live-replay switching tab 24, and a record button 25 are displayed to be superimposed on an image obtained by capturing a three-dimensional shape 31 of a user and a three-dimensional shape 32 of the equipment reconstructed in the virtual three-dimensional space. Note that the visualization information visualizing an exercise of the user is not displayed on the UI screen 21-1 in the normal display mode.

The display mode switching tab 22 is a UI part that is operated when the normal display mode, the joint information visualization display mode, the time-series information visualization display mode, the overlay visualization display mode, and the exaggeration effect visualization display mode are switched.

The status display section 23 displays a status of the user measured by the exercise visualization system 11. In the illustrated example, numerical values indicating the user's balance, heart rate, and calorie consumption are displayed on the status display section 23.

The live-replay switching tab 24 is a UI part that is operated when an exercise visualization image to be displayed is switched between a live image and a replay image. Here, the live image is an exercise visualization image obtained by processing depth images and RGB images output from the sensor units 12-1 to 12-3 in real time. The replay image is an exercise visualization image obtained by processing a depth image and an RGB image recorded in the information processing device 15.

The record button 25 is a UI part that is operated when an instruction is given to record the depth images and the RGB images output from the sensor units 12-1 to 12-3.

Here, the display mode switching tab 22, the status display section 23, the live-replay switching tab 24, and the record button 25 displayed in the normal display mode are displayed in common in the other display modes.

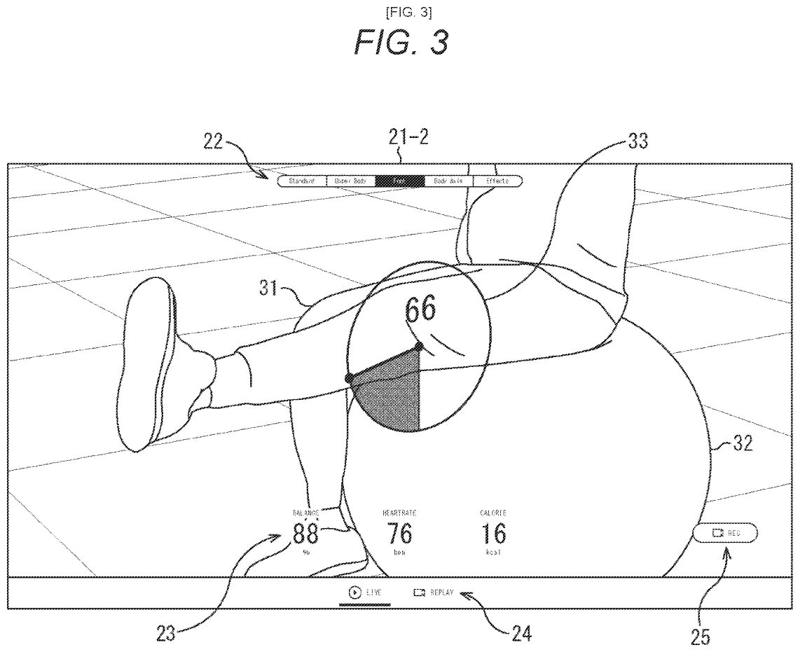

FIG. 3 is a view illustrating an example of a UI screen 21-2 displayed on the tablet terminal 13 in the joint information visualization display mode.

For example, in the joint information visualization display mode, joint information visualizing an exercise of a joint of the user is used as visualization information. Then, the joint information is arranged in the vicinity of the joint of the user reconstructed in the virtual three-dimensional space, and an exercise visualization image is generated by capturing an image by the virtual camera set such that the vicinity of the joint appears to be large.

The UI screen 21-2 illustrated in FIG. 3 illustrates an example in which an exercise of a left knee joint of the user is visualized.

On the UI screen 21-2, as the joint information, a circular graph 33 indicating an angle of the left knee joint of the user (the angle with respect to a straight line extending vertically downward) is arranged in the vicinity of the left knee joint of the three-dimensional shape 31 of the user. For example, the circular graph 33 is three-dimensionally arranged in the vicinity of the outer side of the left knee joint of the three-dimensional shape 31 of the user along a plane orthogonal to a rotation axis of the left knee joint of the three-dimensional shape 31 of the user such that the rotation axis becomes the center. Furthermore, an angle of an area hatched in gray inside the circular graph 33 represents the angle of the left knee joint of the user, and a numerical value indicating the angle is displayed inside the circular graph 33.

For example, in a case where an angle of opening of the knee is larger than a prescribed acceptance angle when the user trains a leg using the joint information visualization display mode, it is possible to notify the user by performing display in which a color of the circular graph 33 changes.

Since the visualization information is presented with the circular graph 33 arranged along the three-dimensional shape 31 of the user on such a UI screen 21-2, the user can intuitively grasp the visualization information from various angles.

Of course, the similar UI screen 21-2 can be displayed for various joints of the user to visualize the joint information without being limited to an exercise of the user bending and stretching the knee joint as illustrated in FIG. 3.

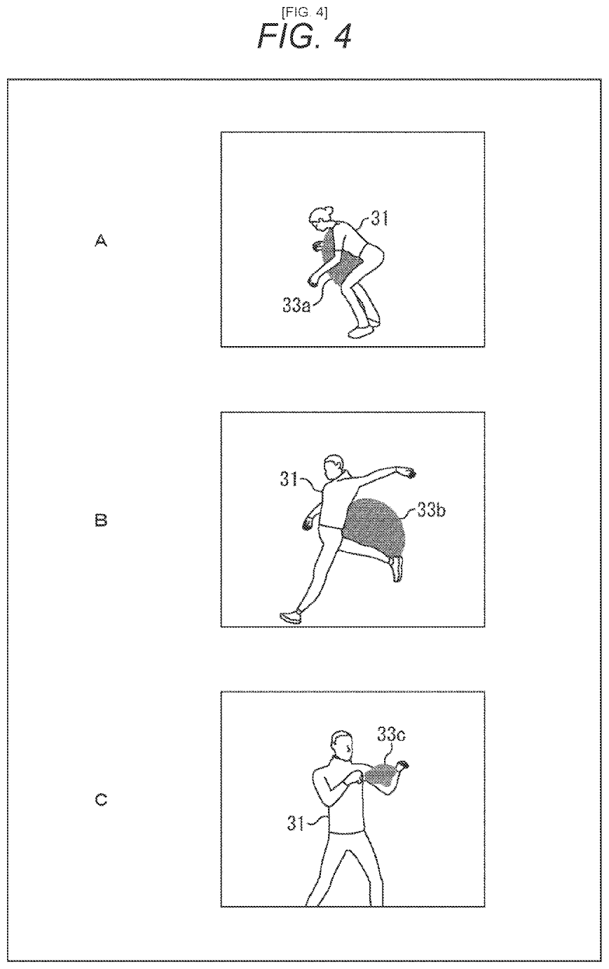

For example, A of FIG. 4 illustrates an example in which an angle of a waist in the three-dimensional shape 31 of a user is visualized, similarly to the area hatched in gray illustrated inside the circular graph 33 of FIG. 3, by joint information 33a representing an angle of the area when the user performs an exercise such as squatting. Furthermore, B of FIG. 4 illustrates an example in which an angle of a knee joint in the three-dimensional shape 31 of a user is visualized by joint information 33b when the user performs an exercise such as kicking in soccer, and C of FIG. 4 illustrates an example in which an angle of an arm joint in the three-dimensional shape 31 of a user is visualized by joint information 33c when the user performs an exercise such as punching in boxing.

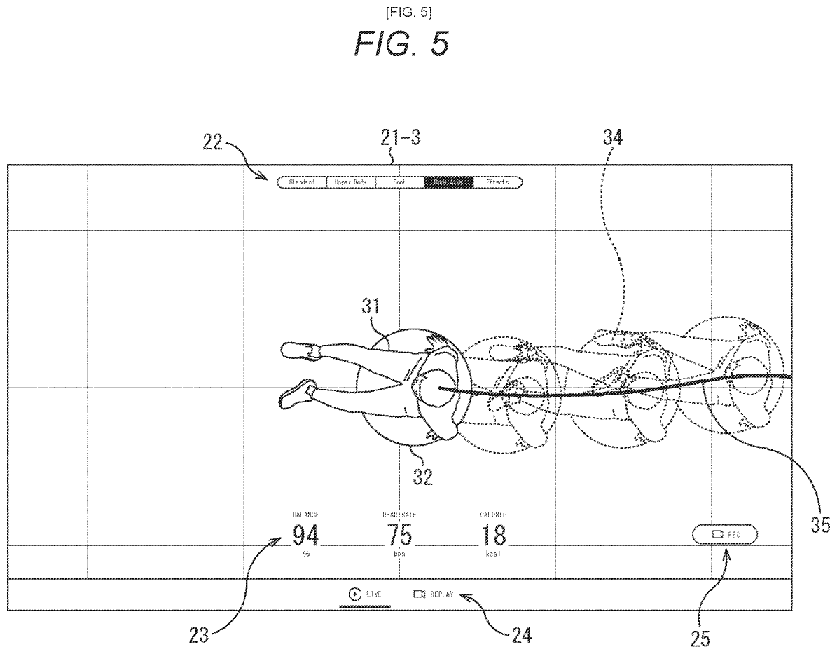

FIG. 5 is a view illustrating an example of a UI screen 21-3 displayed on the tablet terminal 13 in the time-series information visualization display mode.

For example, in the time-series information visualization display mode, time-series information, which visualizes a change with the passage of time in motions of a user, is used as visualization information. Then, an exercise visualization image is generated by capturing an image by the virtual camera set such that the three-dimensional shape 31 of the user reconstructed in the virtual three-dimensional space is looked down.

The UI screen 21-3 illustrated in FIG. 5 illustrates an example of visualizing an exercise in which the user sitting on a balance ball keeps balance.

On the UI screen 21-3, an afterimage 34, obtained by reconstructing past three-dimensional shapes of the user and equipment translucently such that the three-dimensional shapes flow the left side to the right side of the screen at predetermined intervals, and a trajectory 35 linearly expressing a time course of a position of a head of the user are displayed as the visualization information. Furthermore, in the time-series information visualization display mode, an exercise visualization image is captured such that a wide range including the user appears by the virtual camera set to face vertically downward from directly above the three-dimensional shape 31 of the user reconstructed in the virtual three-dimensional space.

With such a UI screen 21-3, the afterimage 34 representing past motions of the user is arranged in the virtual three-dimensional space, or a wobble of the head of the user is displayed on the trajectory 35, so that the user can easily grasp a shake of his/her body.

Of course, it is possible to visualize the time-series information by displaying the similar UI screen 21-3 in various exercises without being limited to the illustrated exercise in which the user keeps the balance.

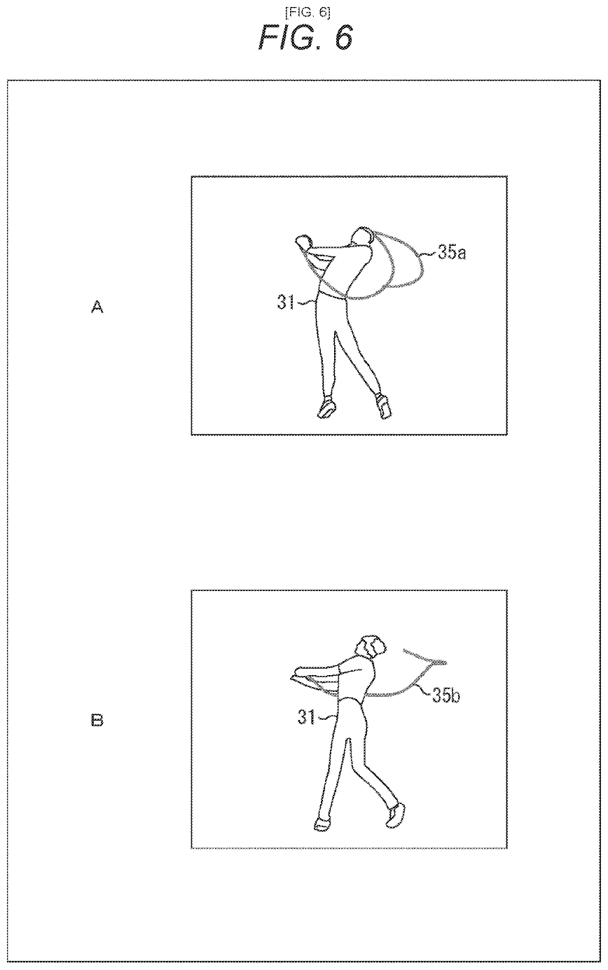

For example, A of FIG. 6 illustrates an example in which a trajectory of a wrist in the three-dimensional shape 31 of a user is visualized by time-series information 35a when the user performs an exercise such as swinging in golf. Furthermore, B of FIG. 6 illustrates an example in which a trajectory of a wrist in the three-dimensional shape 31 of a user is visualized by time-series information 35b when the user performs an exercise such as swinging (batting) in baseball.

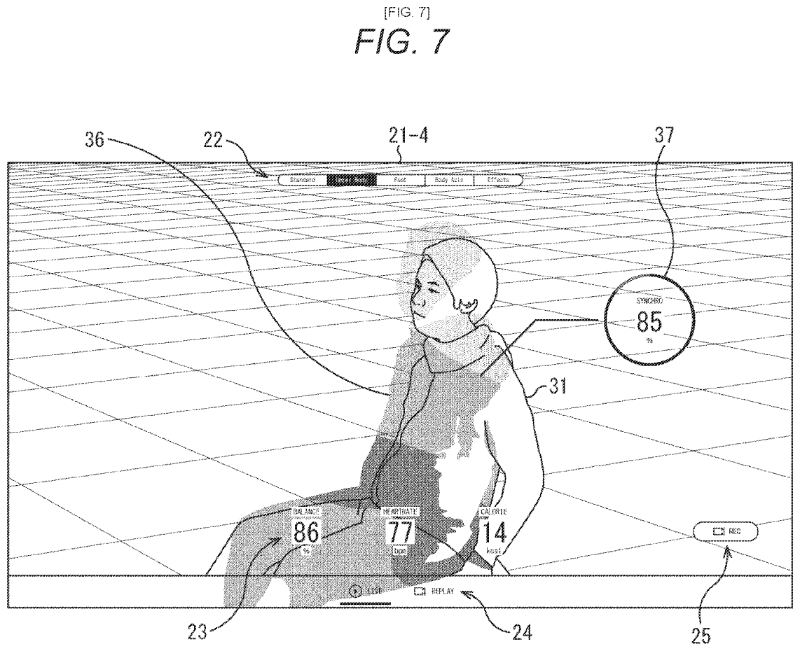

FIG. 7 is a view illustrating an example of a UI screen 21-4 displayed on the tablet terminal 13 in the overlay visualization display mode.

For example, in the overlay visualization display mode, a correct three-dimensional shape registered in advance is used as visualization information. Then, the correct three-dimensional shape is generated so as to be overlaid on the three-dimensional shape 31 of a user reconstructed in the virtual three-dimensional space, and an exercise visualization image is generated by capturing an image by the virtual camera.

The UI screen 21-4 illustrated in FIG. 7 illustrates an example of visualizing an exercise in which the user sitting on a balance ball keeps the balance.

On the UI screen 21-4, as the visualization information, a correct three-dimensional shape 36 at the time of sitting on the balance ball is reconstructed, and a circular graph 37 representing an overall synchronization rate (overall matching rate) between the three-dimensional shape 31 of the user and the correct three-dimensional shape 36 is arranged. Furthermore, in the time-series information visualization display mode, the exercise visualization image is captured by the virtual camera set to reflect an upper body of the three-dimensional shape 31 of the user reconstructed in the virtual three-dimensional space.

Furthermore, a deviation amount of the correct three-dimensional shape 36 is visualized by a heat map in which colors are arranged according to the deviation amount for each joint from the three-dimensional shape 31 of the user. For example, the color arrangement of the heat map is determined such that a bluish color (dark hatching) is used for a joint having a small deviation amount, and a reddish color (light hatching) is used for a joint having a large deviation amount.

Furthermore, the correct three-dimensional shape 36 corresponding to a side surface of a body on the left side, a left arm, or the like of the three-dimensional shape 31 of the user is not displayed on the UI screen 21-4 illustrated in FIG. 7. This indicates that only a portion in front of the three-dimensional shape 31 of the user is created in the correct three-dimensional shape 36, for example, by referring to a depth buffer.

Such a UI screen 21-4 enables visualization in which it is easy to understand which portion (joint position) of the three-dimensional shape 31 of the user deviates from the correct three-dimensional shape 36.

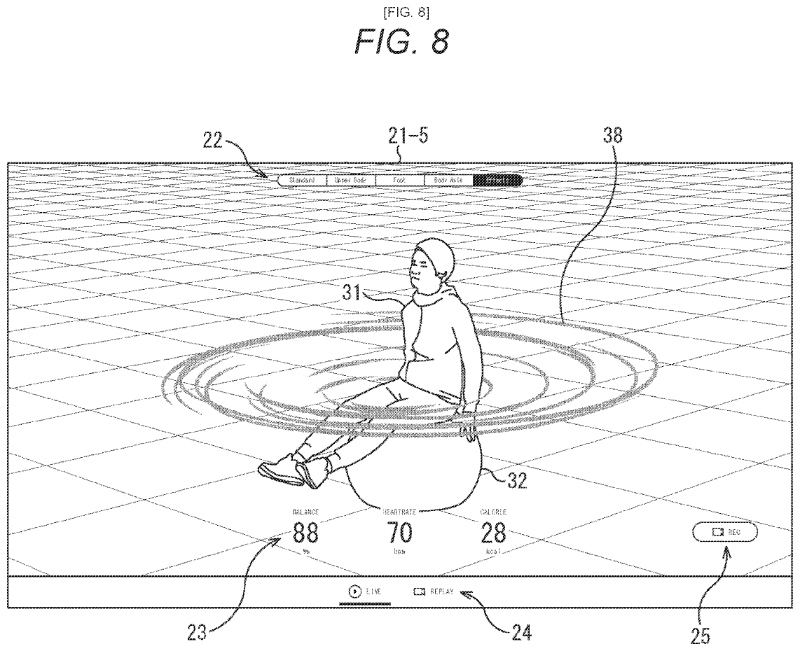

FIG. 8 is a view illustrating an example of a UI screen 21-5 displayed on the tablet terminal 13 in the exaggeration effect visualization display mode.

For example, in the exaggeration effect visualization display mode, an effect of exaggerating an exercise of a user in accordance with the exercise is used as visualization information. Then, an exercise visualization image is generated by capturing an image by the virtual camera set to obtain a bird's-eye view of the three-dimensional shape 31 of the user reconstructed in the virtual three-dimensional space.

The UI screen 21-5 illustrated in FIG. 8 illustrates an example of visualizing an exercise in which the user sitting on a balance ball keeps the balance while tilting his/her body.

On the UI screen 21-5, an effect 38 in which angles and colors of disks are separately drawn so as to exaggerate the exercise of the user in accordance with the balance of the user's body (an angle of a spine) is arranged in the virtual three-dimensional space as the visualization information. For example, the effect 38 is expressed with exaggerated angles larger than an actual tilt of the user's body, and is expressed such that the colors change if the tilt of the user's body is severe.

Of course, it is possible to display the similar UI screen 21-5 in various exercises to perform visualization using the effect without being limited to the illustrated exercise in which the user keeps the balance.

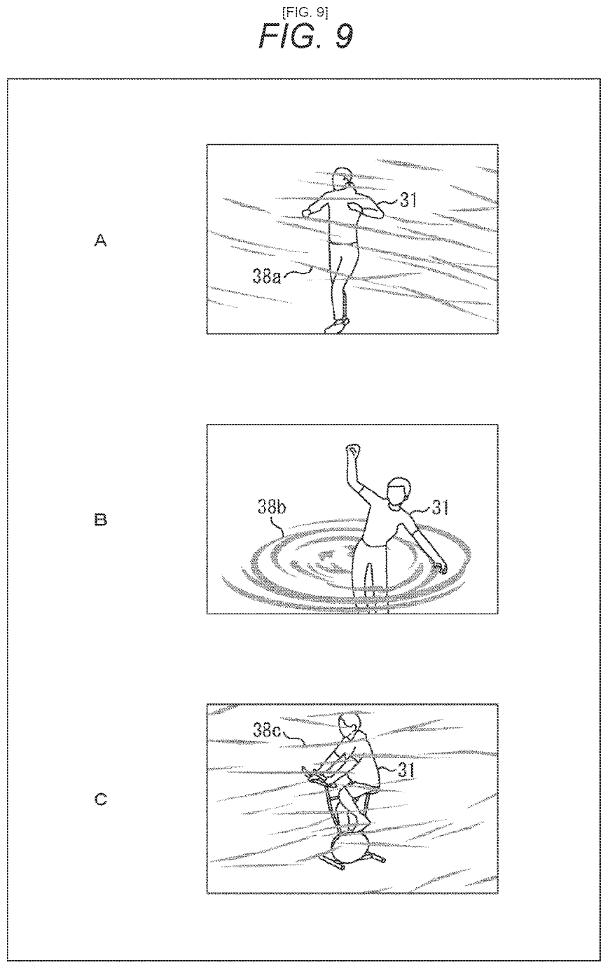

For example, A of FIG. 9 illustrates an example in which, when a user performs an exercise such as dancing, the exercise of the user is visualized so as to be exaggerated by an effect 38a as if an air flow was generated around the user at a velocity corresponding to a speed of a motion of the user. B of FIG. 9 illustrates an example in which, when a user performs an exercise such as throwing a ball, the exercise of the user is visualized so as to be exaggerated by an effect 38b in which the core balance of the user is represented by angles or colors of disks so as to be separately drawn.

C of FIG. 9 illustrates an example in which, when a user performs an exercise such as pedaling bicycle-type fitness equipment, the exercise of the user is visualized so as to be exaggerated by an effect 38c to express wind blowing at a velocity corresponding to a speed at which the user pedals the bicycle-type fitness equipment. For example, it is possible to perform an expression in which a color of the effect 38c changes when the user paddles the bicycle-type fitness equipment too slowly or too fast.

### <Configuration Example of Exercise Visualization System>

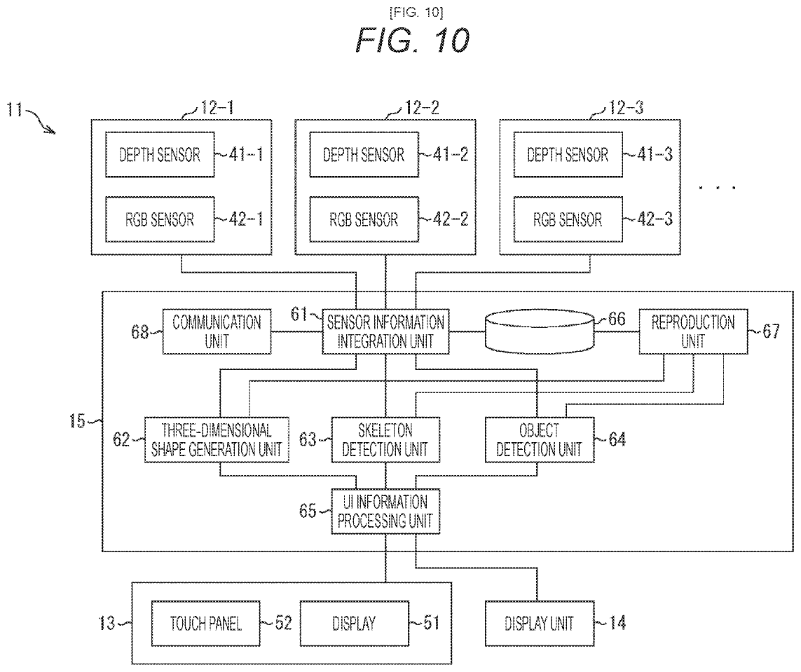

FIG. 10 is a block diagram illustrating a configuration example of the exercise visualization system illustrated in FIG. 1.

As illustrated in FIG. 10, the exercise visualization system 11 has a configuration in which the sensor units 12-1 to 12-3, the tablet terminal 13, and the display device 14 are connected to the information processing device 15. Note that the exercise visualization system 11 may have a configuration in which a plurality of (three or more) sensor units 12 is provided. Furthermore, the sensor units 12-1 to 12-3 will be simply referred to as the sensor unit 12 hereinafter in a case where it is unnecessary to distinguish them.

The sensor unit 12 includes a depth sensor 41 and an RGB sensor 42, and supplies a depth image and an RGB image to the information processing device 15. The depth sensor 41 outputs the depth image acquired by sensing a depth, and the RGB sensor 42 outputs the RGB image captured in color.

The tablet terminal 13 includes a display 51 and a touch panel 52. The display 51 displays a UI screen 21 supplied from the information processing device 15. The touch panel 52 acquires a user operation of touching the display mode switching tab 22, the live-replay switching tab 24, and the record button 25 displayed on the UI screen 21, and supplies operation information indicating a content of the operation to the information processing device 15.

The display device 14 displays an exercise visualization image supplied from the information processing device 15. Note that the display device 14 may display the UI screen 21 similarly to the display 51 of the tablet terminal 13.

The information processing device 15 includes a sensor information integration unit 61, a three-dimensional shape generation unit 62, a skeleton detection unit 63, an object detection unit 64, a UI information processing unit 65, a recording unit 66, a reproduction unit 67, and a communication unit 68.

The sensor information integration unit 61 acquires depth images and the RGB images supplied from the sensor units 12-1 to 12-3, and performs integration processing of performing integration (calibration) in accordance with positions where the sensor units 12-1 to 12-3 are arranged. Then, the sensor information integration unit 61 supplies a depth image and an RGB image subjected to the integration processing to the three-dimensional shape generation unit 62, the skeleton detection unit 63, the object detection unit 64, and the recording unit 66.

The three-dimensional shape generation unit 62 performs three-dimensional shape generation processing of generating three-dimensional shapes of the user and equipment on the basis of the depth image and the RGB image supplied from the sensor information integration unit 61, and supplies three-dimensional shape data obtained as a result of the processing to the UI information processing unit 65.

For example, a technology called three-dimensional reconstruction (3D reconstruction), which is a well-known technology in the field of computer vision, can be generally used for the three-dimensional shape generation processing by the three-dimensional shape generation unit 62. In this technology, basically, a plurality of the depth sensors 41 and a plurality of the RGB sensors 42 are calibrated in advance, and internal parameters and external parameters are calculated. For example, the three-dimensional shape generation unit 62 can perform three-dimensional reconstruction by performing an inverse operation on depth images and RGB images obtained by imaging the user who exercises and output from the depth sensor 41 and the RGB sensor 42 using the internal parameters and external parameters calculated in advance. Note that, in a case where the plurality of depth sensors 41 and the plurality of RGB sensors 42 are used, post-processing of integrating pieces of three-dimensionally reconstructed vertex data may be performed.

The skeleton detection unit 63 performs skeleton detection processing of detecting a skeleton of the user on the basis of the depth image supplied from the sensor information integration unit 61, and supplies skeleton data obtained as a result of the processing to the UI information processing unit 65.

For example, a technology called skeletal (bone) tracking, which is a well-known technology in the field of computer vision, can be generally used for the skeleton detection processing by the skeleton detection unit 63. In this technology, a large number of depth images of a human body imaged in advance are prepared. Then, skeleton position information of the human body is manually registered in the depth images, machine learning is performed, and then, a data set obtained by the machine learning is held. For example, the skeleton detection unit 63 can restore the skeleton position information of the user in real time by applying the data set calculated in advance by the machine learning to a depth image obtained by the depth sensor 41 imaging the user who exercises.

The object detection unit 64 performs object detection processing of detecting an object on the basis of the depth image and the RGB image supplied from the sensor information integration unit 61, and supplies object information obtained as a result of the processing to the UI information processing unit 65.

For example, a technology called object detection, which is a well-known technology in the field of computer vision, can be generally used for the object detection by the object detection unit 64. In this technology, a large number of depth images and RGB images of an object (exercise equipment) imaged in advance are prepared. Then, object information (for example, a name of the equipment or a rectangular position illustrated in an image) is manually registered in the depth images and the RGB images, machine learning is performed, and then, a data set obtained by the machine learning is held. For example, the object detection unit 64 can restore the object information in real time by applying the data set calculated in advance by the machine learning to a depth image and an RGB image obtained by imaging the user who exercises using desired equipment and output from the depth sensor 41 and the RGB sensor 42.

The UI information processing unit 65 reconstructs the three-dimensional shape 31 of the user and the three-dimensional shape 32 of the equipment in the virtual three-dimensional space on the basis of the three-dimensional shape data supplied from the three-dimensional shape generation unit 62. Moreover, the UI information processing unit 65 generates visualization information in accordance with a display mode on the basis of the three-dimensional shape data supplied from the three-dimensional shape generation unit 62, the skeleton data supplied from the skeleton detection unit 63, and the object information supplied from the object detection unit 64, and arranges the visualization information at an appropriate position in the virtual three-dimensional space.

Then, the UI information processing unit 65 generates an exercise visualization image by capturing the three-dimensional shape 31 of the user and the three-dimensional shape 32 of the equipment by the virtual camera arranged in the virtual three-dimensional space so as to be at a position corresponding to the display mode. Moreover, the UI information processing unit 65 generates the UI screen 21 by superimposing the display mode switching tab 22, the status display section 23, the live-replay switching tab 24, and the record button 25 on the exercise visualization image. The UI information processing unit 65 supplies the UI screen 21 to the tablet terminal 13 and the display device 14 for display.

Furthermore, the UI information processing unit 65 can switch the display mode such that the position of the virtual camera arranged in the virtual three-dimensional space smoothly moves in response to the user operation on the touch panel 52 of the tablet terminal 13.

The recording unit 66 records the depth image and the RGB image supplied from the sensor information integration unit 61.

The reproduction unit 67 reads and reproduces the depth image and the RGB image recorded in the recording unit 66 in response to the user operation on the touch panel 52 of the tablet terminal 13, and supplies the depth image and the RGB image to the three-dimensional shape generation unit 62, the skeleton detection unit 63, and the object detection unit 64.

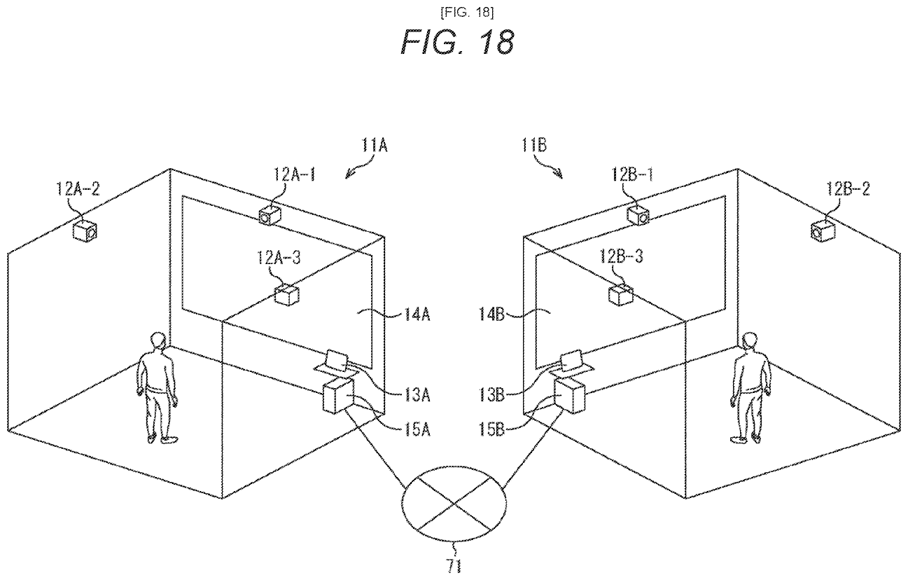

The communication unit 68 can communicate with another exercise visualization system 11, for example, as described later with reference to FIGS. 18 to 20. Then, the communication unit 68 can transmit and receive the depth image and the RGB image supplied from the sensor information integration unit 61, and can transmit and receive the operation data.

### <Processing Example of Exercise Visualization Processing>

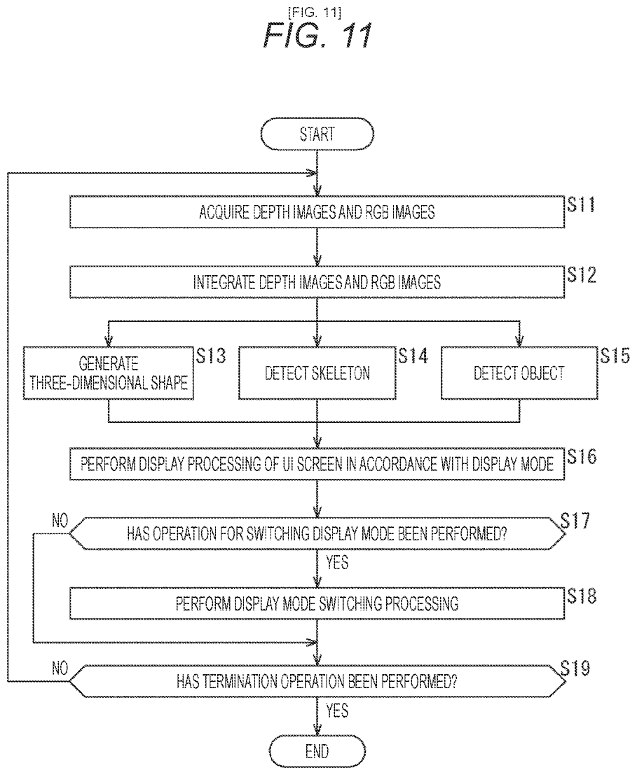

FIG. 11 is a flowchart for describing exercise visualization processing by the exercise visualization system 11.

For example, the processing is started when the exercise visualization system 11 is activated, and each of the sensor units 12-1 to 12-3 acquires a depth image and an RGB image and supplies the depth image and the RGB image to the information processing device 15 in step S11.

In step S12, in the information processing device 15, the sensor information integration unit 61 performs integration processing of integrating the depth images and the RGB images supplied from the sensor units 12-1 to 12-3 in step S11. Then, the sensor information integration unit 61 supplies a depth image and an RGB image subjected to the integration processing to the three-dimensional shape generation unit 62, the skeleton detection unit 63, and the object detection unit 64.

Processing of each of steps S13 to S15 is performed in parallel.

In step S13, the three-dimensional shape generation unit 62 performs three-dimensional shape generation processing of generating three-dimensional shapes of the user and the equipment on the basis of the depth image and the RGB image supplied from the sensor information integration unit 61 in step S12. Then, the three-dimensional shape generation unit 62 supplies three-dimensional shape data obtained as a result of performing the three-dimensional shape generation processing to the UI information processing unit 65.

In step S14, the skeleton detection unit 63 performs skeleton detection processing of detecting a skeleton of the user on the basis of the depth image supplied from the sensor information integration unit 61 in step S12. Then, the skeleton detection unit 63 supplies skeleton data obtained as a result of performing the skeleton detection processing to the UI information processing unit 65.

In step S15, the object detection unit 64 performs object detection processing of detecting an object on the basis of the depth image and the RGB image supplied from the sensor information integration unit 61 in step S12. Then, the object detection unit 64 supplies object information obtained as a result of performing the object detection processing to the UI information processing unit 65.

In step S16, the UI information processing unit 65 uses the three-dimensional shape data supplied from the three-dimensional shape generation unit 62 in step S13, the skeleton data supplied from the skeleton detection unit 63 in step S14, and the object information supplied from the UI information processing unit 65 in step S15 to perform display processing of generating the UI screen 21 in accordance with a currently set display mode and displaying the UI screen 21 on the tablet terminal 13.

In step S17, the UI information processing unit 65 determines whether or not an operation for switching the display mode has been performed in accordance with operation information supplied from the touch panel 52 of the tablet terminal 13.

In step S17, in a case where the UI information processing unit 65 determines that the operation for switching the display mode has been performed, that is, in a case where the user has performed a touch operation on the display mode switching tab 22, the processing proceeds to step S18.

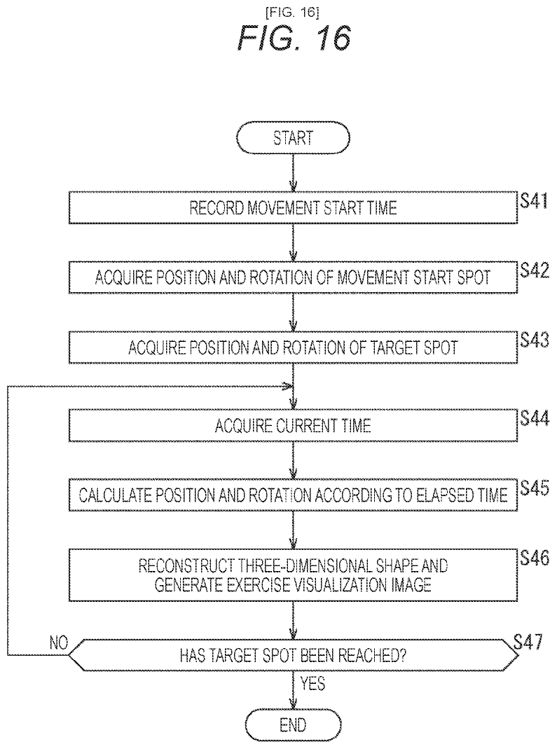

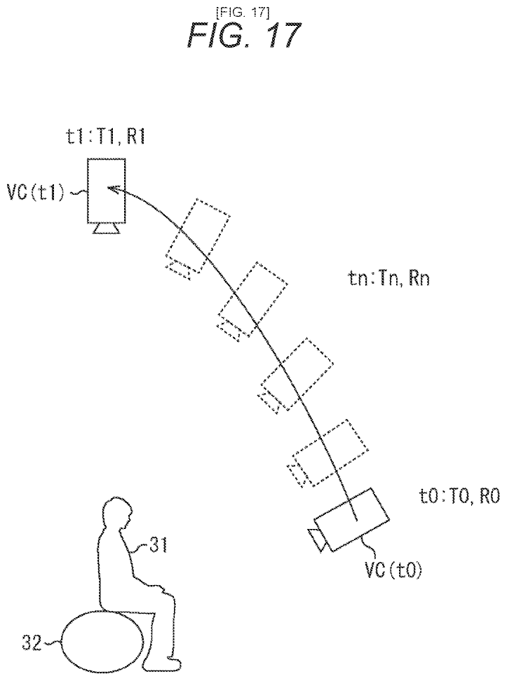

In step S18, the UI information processing unit 65 performs display mode switching processing so as to switch to a display mode selected by the touch operation on the display mode switching tab 22. At this time, in the display mode switching processing, the display mode is switched such that a position of the virtual camera arranged in the virtual three-dimensional space smoothly moves as described later with reference to FIGS. 16 and 17.

After the processing of step S18 or in a case where it is determined in step S17 that the operation for switching the display mode has not been performed, the processing proceeds to step S19.

In step S19, it is determined whether or not a termination operation by the user has been performed.

In a case where it is determined in step S19 that the termination operation by the user has not been performed, the processing returns to step S11, and similar processing is repeatedly performed thereafter. On the other hand, in a case where it is determined in step S19 that the termination operation by the user has been performed, the processing is terminated.

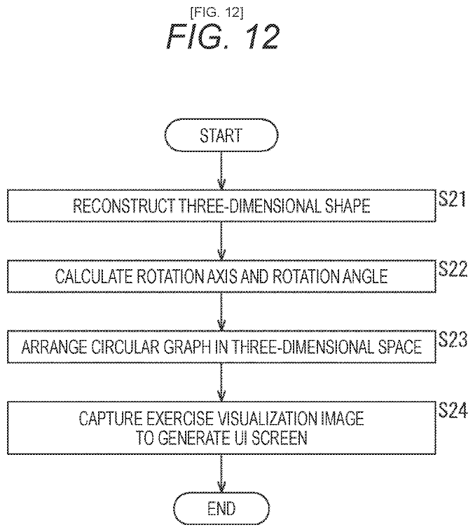

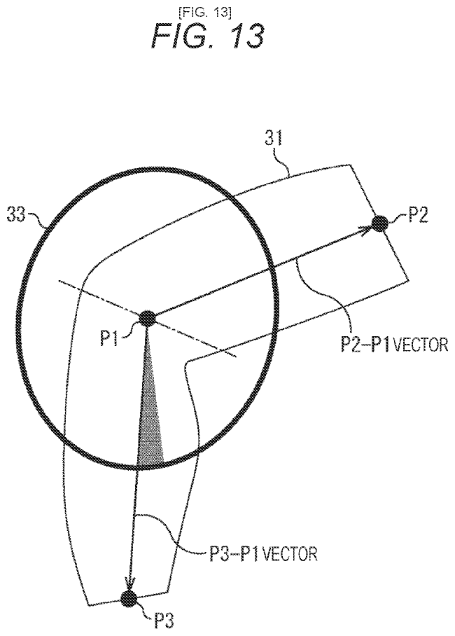

Display processing of displaying the UI screen 21-2 in the joint information visualization display mode illustrated in FIG. 3 on the tablet terminal 13 in the display processing of the UI screen 21 performed in step S16 of FIG. 11 will be described with reference to FIGS. 12 and 13.

FIG. 12 is a flowchart illustrating the display processing of the UI screen 21-2 in the joint information visualization display mode.

In step S21, the UI information processing unit 65 reconstructs the three-dimensional shape 31 of the user in the virtual three-dimensional space on the basis of the three-dimensional shape data of the user supplied from the three-dimensional shape generation unit 62.

In step S22, the UI information processing unit 65 calculates a rotation axis and a rotation angle of a joint whose joint information is to be displayed on the basis of the skeleton data supplied from the skeleton detection unit 63.

Here, in a case where joint information of the left knee joint of the user is to be displayed as illustrated in FIG. 13, the UI information processing unit 65 acquires a joint position P1 of the left knee of the user, a parent joint position P2 of a left hip joint, which is a parent joint with respect to the joint position P1, and a child joint position P3 of a left ankle, which is a child joint with respect to the joint position P1, from the skeleton data supplied from the skeleton detection unit 63. Then, the UI information processing unit 65 calculates an outer product of a vector from the joint position P1 toward the parent joint position P2 and a vector from the joint position P1 toward the child joint position P3, thereby calculating the rotation axis and the rotation angle (angle with the vertically downward direction) of the left knee joint of the user.

In step S23, the UI information processing unit 65 arranges the circular graph 33 created on the basis of the rotation axis and the rotation angle of the joint calculated in step S22 in the virtual three-dimensional space obtained by reconstructing the three-dimensional shape 31 of the user in step S21. At this time, for example, the UI information processing unit 65 arranges the circular graph 33 in the vicinity of the joint such that the center of the circular graph 33 coincides with the rotation axis of the joint indicated by a one-dot chain line in FIG. 13.

In step S24, the UI information processing unit 65 captures the three-dimensional shape 31 and the circular graph 33 of the user with the virtual camera set such that the vicinity of the joint whose joint information is to be displayed appear to be large, and generates an exercise visualization image. Then, the UI information processing unit 65 superimposes UI parts and the like on the exercise visualization image as illustrated in FIG. 3 to generate the UI screen 21-2 in the joint information visualization display mode, and supplies the UI screen 21-2 to the tablet terminal 13 for display.

With the display processing as described above, the information can be visualized in a form along the actual three-dimensional shape on the UI screen 21-2 in the joint information visualization display mode, and the information can be intuitively grasped from various angles.

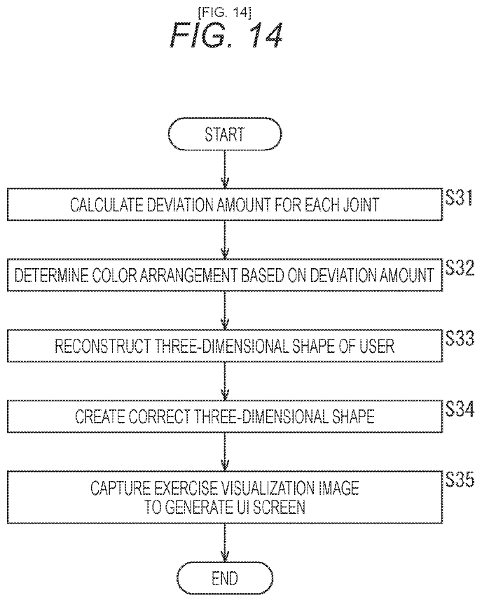

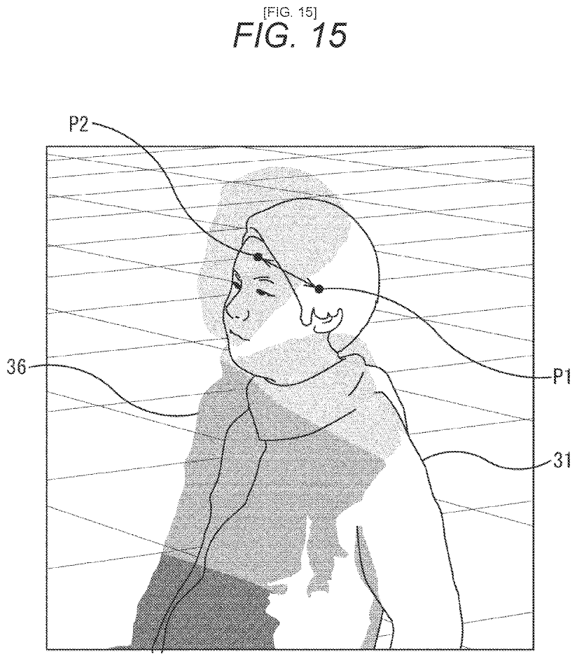

Display processing of displaying the UI screen 21-4 in the overlay visualization display mode illustrated in FIG. 7 on the tablet terminal 13 in the display processing of the UI screen 21 performed in step S16 of FIG. 11 will be described with reference to FIGS. 14 and 15.

FIG. 14 is a flowchart for describing display processing of the UI screen 21-4 in the overlay visualization display mode.

In step S31, the UI information processing unit 65 calculates a deviation amount for each joint on the basis of the skeleton data supplied from the skeleton detection unit 63 and correct skeleton data registered in advance. Here, in FIG. 15, as an example of the deviation amount of the joint calculated in step S31, a deviation amount between a joint position P1 of the head based on the skeleton data supplied from the skeleton detection unit 63 and a joint position P2 of the head based on the correct skeleton data is indicated by an arrow.

In step S32, the UI information processing unit 65 determines a color arrangement (depth of gray hatching in the example illustrated in FIG. 15) based on the deviation amount calculated for each joint in step S31. For example, the UI information processing unit 65 determines the color arrangement such that a bluish color (dark hatching) is used for a joint having a small deviation amount, and a reddish color (light hatching) is used for a joint having a large deviation amount. Of course, the color arrangement is similarly determined for joints other than the joint of the head illustrated in FIG. 15.

In step S33, the UI information processing unit 65 reconstructs the three-dimensional shape 31 of the user in the virtual three-dimensional space on the basis of the three-dimensional shape data of the user supplied from the three-dimensional shape generation unit 62.

In step S34, the UI information processing unit 65 creates the correct three-dimensional shape 36 in the virtual three-dimensional space on the basis of the correct skeleton data such that a surface is drawn with colors of predetermined transmittances so as to have the color arrangement determined in step S32. At this time, the UI information processing unit 65 refers to a depth buffer to create only the correct three-dimensional shape 31 in a portion in front of the three-dimensional shape 36 of the user.

In step S35, the UI information processing unit 65 captures the three-dimensional shape 31 of the user and the correct three-dimensional shape 36 with the virtual camera set to reflect an upper body of the user appears, and generates an exercise visualization image. Then, the UI information processing unit 65 superimposes UI parts and the like on the exercise visualization image as illustrated in FIG. 7 to generate the UI screen 21-4 in the joint information visualization display mode, and supplies the UI screen 21-4 to the tablet terminal 13 for display.

With the display processing as described above, it is possible to present information that allows the user to intuitively understand a deviation between the correct three-dimensional shape 36 and the user's own three-dimensional shape 31 on the UI screen 21-4 in the overlay visualization display mode.

The display mode switching processing performed in step S18 of FIG. 11 will be described with reference to FIGS. 16 and 17. Here, display mode switching processing for switching the display of the tablet terminal 13 to the UI screen 21-3 in the time-series information visualization display mode illustrated in FIG. 3 will be described.

FIG. 16 is a flowchart illustrating the display mode switching processing.

In step S41, the UI information processing unit 65 records, as a movement start time t0, a timing at which the user performs an operation on the display mode switching tab 22 displayed on the tablet terminal 13 and the operation is performed so as to display the time-series information visualization display mode.

In step S42, as illustrated in FIG. 17, the UI information processing unit 65 also records a start position TO and a start rotation R0 indicating an initial start spot of a virtual camera VC(t0) arranged in the virtual three-dimensional space at the movement start time t0.

In step S43, the UI information processing unit 65 acquires a target position T1 and a target rotation R1 indicating a target spot of a virtual camera VC(t1) at a target time t1 at which the switching of the display mode is completed. Here, in a case where the display mode is switched to the time-series information visualization display mode, it is desired to visualize a shake of the head on the balance ball. Thus, as illustrated in FIG. 17, a position directly above the user to be imaged is the target position T1 of the virtual camera VC(t1), and a direction vertically downward from the position is the target rotation R1 of the virtual camera VC(t1).

In step S44, the UI information processing unit 65 acquires a current time tn according to a timing every frame after the movement start time t0.

In step S45, the UI information processing unit 65 calculates a position Tn at the current time tn from the start position T0 to the target position T1 and a rotation Rn at the current time tn from the start rotation R0 to the target rotation R1 by interpolation on the basis of an elapsed time (tn−t0).

In step S46, the UI information processing unit 65 reconstructs the three-dimensional shape 31 of the user in the virtual three-dimensional space, and captures an image at a viewpoint of the virtual camera set at the position Tn and the rotation Rn calculated in step S35 to generate an exercise visualization image. Then, the UI information processing unit 65 generates the UI screen 21 from the exercise visualization image, supplies the UI screen 21 to the tablet terminal 13 for display.

In step S47, the UI information processing unit 65 determines whether or not the position Tn and the rotation Rn of the virtual camera at this time have reached the target position T1 and the target rotation R1 of the target spot acquired in step S43.

In a case where the UI information processing unit 65 determines in step S47 that the virtual camera has not reached the target position T1 and the target rotation R1 of the target spot, the processing returns to step S44, and similar processing is repeatedly performed thereafter. On the other hand, in a case where the UI information processing unit 65 determines in step S47 that the virtual camera has reached the target position T1 and the target rotation R1 of the target spot, the processing is terminated.

Since the display mode switching processing as described above is performed, the viewpoint of the virtual camera is automatically and smoothly switched from the moment when the user has performed the operation for switching the display mode, and a view that facilitates training can be presented.

Note that, in addition to switching the display mode in response to the user operation, for example, the display mode may be automatically switched in response to a timing at which a training task is completed according to a training menu set in advance.

### <Remote Coaching of Exercise Visualization System>

With reference to FIGS. 18 to 20, an example of use remote coaching using the exercise visualization system 11 will be described.

FIG. 18 illustrates a configuration example of a remote system in which an exercise visualization system 11A and an exercise visualization system 11B are connected via a network 71.

The exercise visualization system 11A and the exercise visualization system 11B are configured similarly to the exercise visualization system 11 illustrated in FIG. 1. When such a remote system is used, a teacher in a remote place and a student cooperate with each other by communication, so that it is possible to provide remote coaching for training.

For example, the teacher can use the exercise visualization system 11A and the student can use the exercise visualization system 11B to transmit three-dimensional shape data, skeleton data, and object information of the teacher from the exercise visualization system 11A to the exercise visualization system 11B. In this case, the exercise visualization system 11B on the student side can display a three-dimensional video of the teacher, and can effectively show a role model. Furthermore, the exercise visualization system 11B combines and displays the three-dimensional video of the teacher with a three-dimensional video of the student, and thus, can perform an expression as if the teacher was on that place.

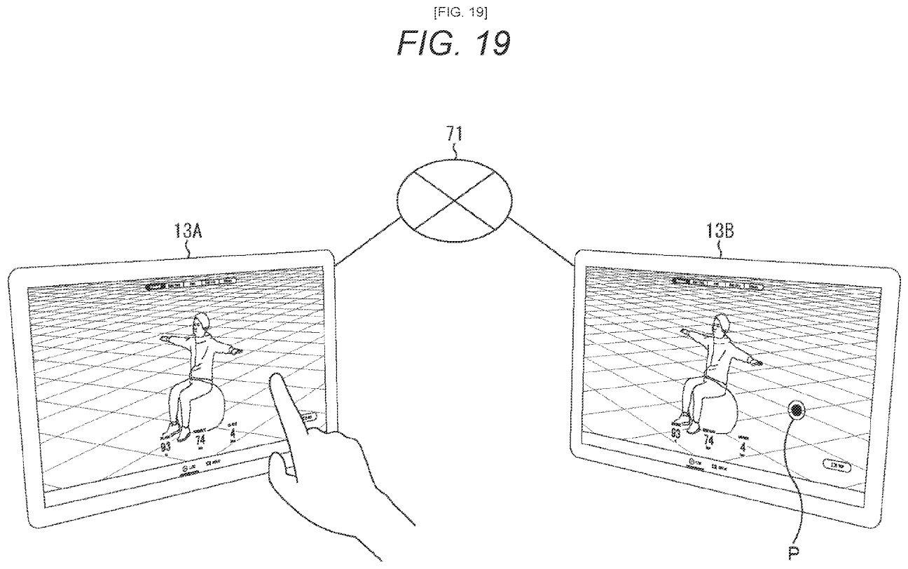

Furthermore, as illustrated in FIG. 19, when the teacher performs an operation of touching a tablet terminal 13A of the exercise visualization system 11A, operation data indicating such a touched position is transmitted from the exercise visualization system 11A to the exercise visualization system 11B. Then, a cursor is displayed at a point P that is a display position corresponding to the teacher's touch position on a tablet terminal 13B of the exercise visualization system 11B. Furthermore, when the teacher side moves a viewpoint of a virtual camera by a touch operation, a viewpoint also moves and is displayed such that an exercise visualization image displayed on the student side is also linked. Furthermore, when the teacher gives an instruction by voice while touching the three-dimensional video, such voice data is transmitted from the exercise visualization system 11A to the exercise visualization system 11B, and the coaching for training can be effectively performed.

Note that, in addition to the remote system as illustrated in FIG. 18, a simple remote system in which the exercise visualization system 11A is used on the student side and only the tablet terminal 13B is used on the teacher side may be used. Also in this case, remote coaching as described with reference to FIG. 19 can be performed.

The remote system including the exercise visualization system 11A and the exercise visualization system 11B may be used to correspond to, for example, the use of sports by multiple people such as boxing. In this case, for example, visualization of a distance between two users, visualization of timings of operations of the two users, and the like are performed.

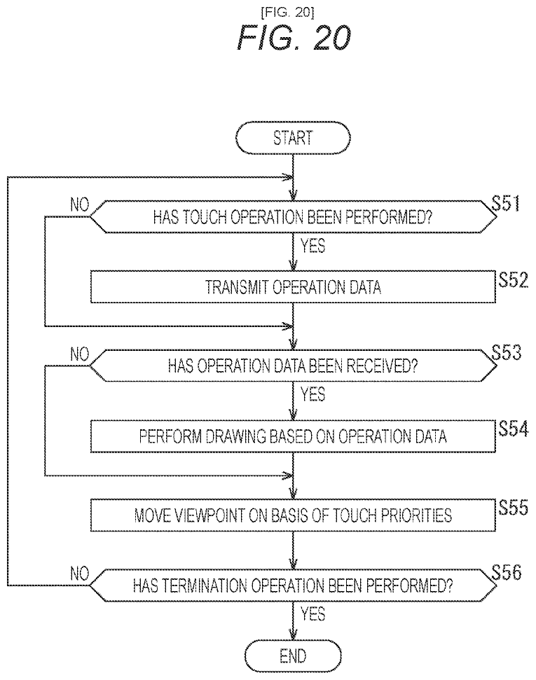

A processing example of processing executed in the remote system will be described with reference to a flowchart illustrated in FIG. 20.

In step S51, the tablet terminal 13A of the exercise visualization system 11A determines whether or not the touch operation by the teacher has been performed.

In a case where it is determined in step S51 that the touch operation has been performed, the processing proceeds to step S52, and the tablet terminal 13A acquires operation data (for example, a touch coordinate) according to the touch operation by the teacher and transmits the operation data to the exercise visualization system 11B via the network 71. At this time, in a case where the voice of the teacher is acquired together with the touch operation, the tablet terminal 13A transmits the voice data together with the operation data.

After the processing in step SS52 or in a case where it is determined in step S51 that the touch operation has not been performed, the processing proceeds to step S53.

In step S53, the tablet terminal 13B of the exercise visualization system 11B determines whether or not the operation data transmitted from the exercise visualization system 11A has been received.

In a case where it is determined in step S53 that the operation data has been received, the processing proceeds to step S54, and the tablet terminal 13B draws the cursor to the point P on the basis of the operation data. At this time, in a case where the voice data has been received together with the operation data, the tablet terminal 13B reproduces the voice of the teacher on the basis of the voice data.

After the processing of step S54 or in a case where it is determined in step S53 that the operation data has not been received, the processing proceeds to step S55.

In step S55, the viewpoint of the virtual camera is moved on the basis of touch priorities of the teacher on the exercise visualization system 11A side and the student on the exercise visualization system 11B side. For example, in a case where the teacher on the exercise visualization system 11A side is set to have a higher touch priority than the student on the exercise visualization system 11B side, the viewpoint of the virtual camera moves on the basis of the operation data of the teacher if the operation data has been received in step S53. Furthermore, in this case, if the operation data has not been received in step S53, the viewpoint of the virtual camera moves on the basis of the operation data of the student.

In step S56, it is determined whether or not a termination operation by the teacher or the student has been performed.

In a case where it is determined in step S56 that the termination operation by the teacher or the student has not been performed, the processing returns to step S51, and the similar processing is repeatedly performed thereafter. On the other hand, in a case where it is determined in step S56 that the termination operation by the teacher or the student has been performed, the processing is terminated.

### <Use Examples of Projection Mapping>

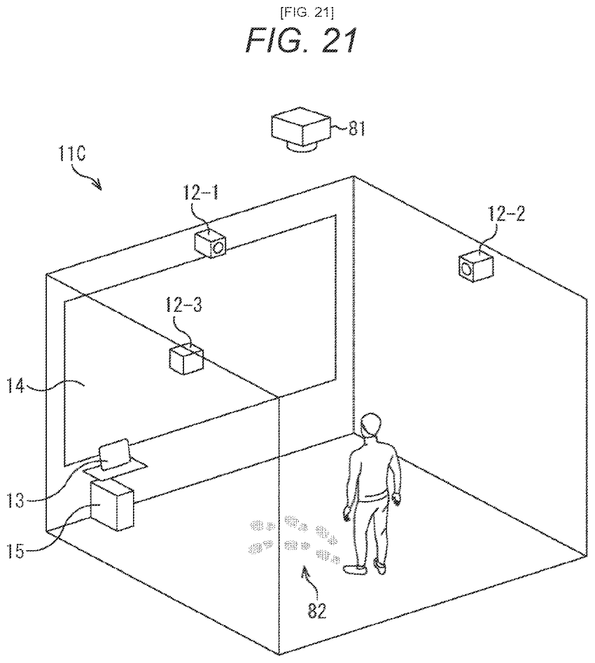

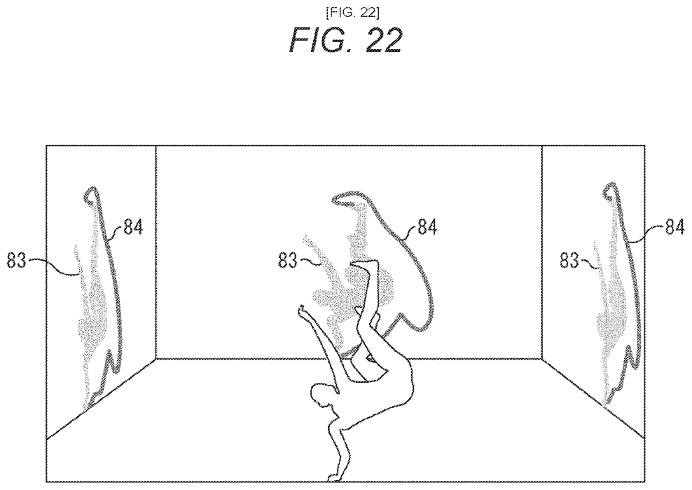

Use examples of projection mapping by the exercise visualization system 11 will be described with reference to FIGS. 21 and 22.

An exercise visualization system 11C illustrated in FIG. 21 includes a projector 81 installed on a ceiling in addition to the configuration example of the exercise visualization system 11 illustrated in FIG. 1.

The projector 81 can project an image on a floor or a wall surface of a training room in which the exercise visualization system 11C is installed. For example, in the example illustrated in FIG. 21, footprints 82 are projected by the projector 81, and a user can practice footwork (such as dance steps).

Furthermore, as illustrated in FIG. 22, it is possible to use such that a silhouette 83 of a user and a trajectory 84 of a foot are projected on three wall surfaces of a training room in which the exercise visualization system 11C is installed. In this manner, in the exercise visualization system 11C, the user can view the user's own silhouette 83 from all sides and intuitively confirm how to raise the foot through visualization of a height of the foot with the trajectory 84. Note that the visualization may be performed with a horizontal straight line representing the height of the foot.

Note that, as a display method of the exercise visualization system 11, augmented reality (AR) glasses, a virtual reality (VR) headset, and the like can be used in addition to the display device 14, the projector 81, and the like.

Furthermore, the exercise visualization system 11 can be used to confirm results of training (for example, growth for three months and the like) of each user by performing long-term recording of each user. Furthermore, the exercise visualization system 11 may be used to allow users who use the exercise visualization system 11 to compare results of training with each other. Furthermore, the exercise visualization system 11 can propose an optimal training plan for the future by statistically processing results of training.

### <Configuration Example of Computer>

Next, a series of the processes described above (an information processing method) may be performed by hardware or can be performed by software. In a case where the series of the processes is performed by the software, a program constituting the software is installed on a general-purpose computer, and the like.

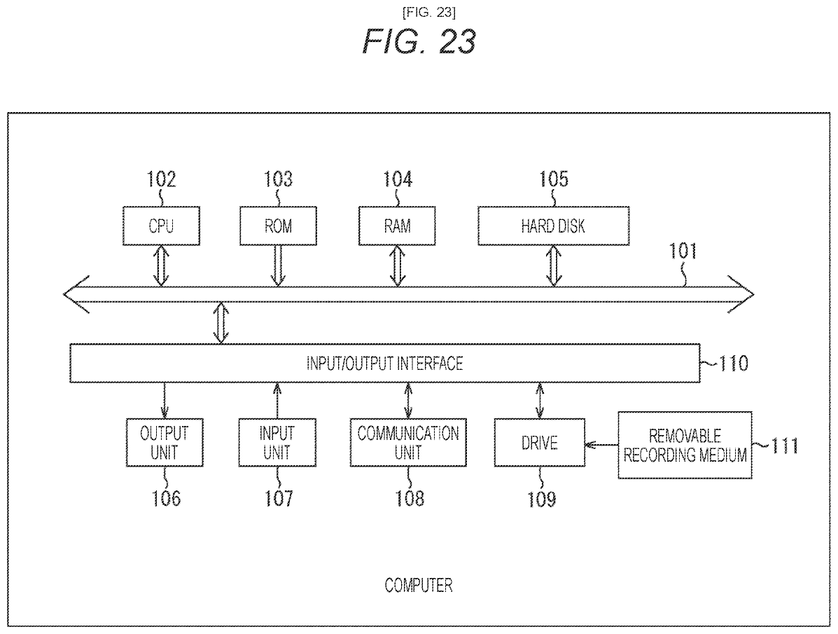

FIG. 23 is a block diagram illustrating a configuration example of an embodiment of a computer on which a program for executing the series of the processes described above is installed.

The program can be recorded in advance on a hard disk 105 or ROM 103 as a recording medium incorporated in the computer.

Alternatively, the program can also be stored (recorded) in a removable recording medium 111 driven by a drive 109. Such a removable recording medium 111 can be provided as so-called package software. Here, examples of the removable recording medium 111 include, for example, a flexible disk, a compact disc read only memory (CD-ROM), a magneto optical (MO) disk, a digital versatile disc (DVD), a magnetic disk, a semiconductor memory, and the like.

Note that, in addition to installing the program on the computer from the removable recording medium 111 as described above, the program can be downloaded to the computer via a communication network or a broadcasting network and installed on the hard disk 105 to be incorporated. In other words, for example, the program can be wirelessly transferred from a download site to the computer via an artificial satellite for digital satellite broadcasting, or can be transferred by a wire to the computer via a network such as a local area network (LAN) and the Internet.

The computer has a built-in central processing unit (CPU) 102, and an input/output interface 110 is connected to the CPU 102 via a bus 101.

When a command is inputted by the user, for example, operating an input unit 107 via the input/output interface 110, accordingly, the CPU 102 executes a program stored in the read only memory (ROM) 103. Alternatively, the CPU 102 loads a program stored in the hard disk 105 into a random access memory (RAM) 104 to execute the program.

Therefore, the CPU 102 performs the processing according to the above-described flowchart or the processing performed by the configuration of the above-described block diagram. Then, as necessary, the CPU 102 outputs a processing result from an output unit 106, or transmits the processing result from a communication unit 108, and further, causes the hard disk 105 to record the processing result, and the like, via the input/output interface 110, for example.

Note that, the input unit 107 includes a keyboard, a mouse, a microphone, and the like. Furthermore, the output unit 106 includes a liquid crystal display (LCD), a speaker, and the like.

Herein, in the present specification, the processing to be performed by the computer in accordance with the program is not necessarily performed on a time-series basis according to the sequences described in the flowcharts. That is, the processing to be performed by the computer in accordance with the program includes processing to be executed in parallel or independently of one another (parallel processing or object-based processing, for example).

Furthermore, the program may be processed by one computer (one processor) or processed in a distributed manner by a plurality of computers. Moreover, the program may be transferred to a distant computer to be executed.

Moreover, in the present description, a system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Furthermore, for example, a configuration described as one device (or one processing unit) may be divided and configured as the plurality of the devices (or the processing units). Conversely, configurations described above as a plurality of devices (or processing units) may be collectively configured as one device (or processing unit). Furthermore, a configuration other than the configurations described above may be added to the configuration of each device (or each processing unit). Moreover, if the configuration and operation of the entire system are substantially the same, a part of the configuration of a certain device (or a certain processing unit) may be included in the configuration of another device (or another processing unit).

Furthermore, for example, the present technology may be configured as cloud computing in which one function is shared by a plurality of devices through a network for processing in cooperation.

Furthermore, for example, the program described above can be executed by any device. In this case, the device is only required to have a necessary function (a functional block and the like) and obtain necessary information.

Furthermore, for example, each step described in the flowcharts described above can be executed by one device, or can be executed in a shared manner by the plurality of the devices. Moreover, in a case where a plurality of processes is included in one step, the plurality of the processes included in the one step can be executed by one device or shared and executed by the plurality of the devices. In other words, the plurality of the processes included in one step can also be executed as processes of a plurality of steps. Conversely, the processes described as the plurality of the steps can also be collectively executed as one step.

Note that, in the program to be executed by the computer, the processes in steps describing the program may be executed in time series in the order described in the present description, or may be executed in parallel, or independently at a necessary timing such as when a call is made. That is, unless there is a contradiction, the process in the each step may also be executed in an order different from the orders described above. Moreover, the processes in the steps describing the program may be executed in parallel with processes of another program, or may be executed in combination with processes of the other program.

Note that, a plurality of the present technologies that has been described in the present description can each be implemented independently as a single unit unless there is a contradiction. Of course, a plurality of arbitrary present technologies can be implemented in combination. For example, a part or all of the present technologies described in any of the embodiments can be implemented in combination with a part or all of the present technologies described in other embodiments. Furthermore, a part or all of the present technologies described above may be implemented in combination with another technology not described above.

### <Combination Examples of Configurations>

Note that the present technology can also have the following configuration.

(1)

An information processing device including:
a three-dimensional shape generation unit that generates three-dimensional shape data representing a three-dimensional shape of a user on the basis of a depth image and an RGB image;
a skeleton detection unit that generates skeleton data representing a skeleton of the user on the basis of the depth image; and
a visualization information generation unit that generates visualization information for visualizing an exercise of the user using the three-dimensional shape data and the skeleton data, and arranges and captures the visualization information on the three-dimensional shape of the user reconstructed in a virtual three-dimensional space on the basis of the three-dimensional shape data to generate an exercise visualization image.
   (2)

The information processing device according to (1) described above, further including
an object detection unit that recognizes equipment used by the user on the basis of the depth image and the RGB image.
   (3)

The information processing device according to (1) or (2) described above, in which
the visualization information generation unit generates the exercise visualization image by a virtual camera set in the virtual three-dimensional space in accordance with a plurality of display modes prepared in advance.
   (4)

The information processing device according to (3) described above, in which
in a case where the display mode is a joint information visualization display mode, the visualization information generation unit generates the exercise visualization image by arranging, as the visualization information, joint information indicating an angle of a joint in a vicinity of the joint of the user reconstructed in the virtual three-dimensional space and setting the virtual camera to reflect the joint to be large.
   (5)

The information processing device according to any of (1) to (4) described above, in which
when the user performs a squat exercise, the visualization information generation unit visualizes the exercise by joint information indicating an angle of a waist of the user.
   (6)

The information processing device according to any of (1) to (4) described above, in which
when the user performs a kick exercise in soccer, the visualization information generation unit visualizes the exercise by joint information indicating an angle of a knee joint of the user.
   (7)

The information processing device according to any of (1) to (4) described above, in which
when the user performs a punch exercise in boxing, the visualization information generation unit visualizes the exercise by joint information indicating an angle of a joint of an arm of the user.
   (8)

The information processing device according to (3) described above, in which
in a case where the display mode is a time-series information visualization display mode, the visualization information generation unit sets the virtual camera to face vertically downward from directly above the user reconstructed in the virtual three-dimensional space, and generates the exercise visualization image in which past three-dimensional shapes of the user are displayed as the visualization information to flow at a predetermined interval and a trajectory linearly expressing a time course of a position of a head of the user is displayed as the visualization information.
   (9)

The information processing device according to any of (1) to (8) described above, in which
when the user performs a swing exercise in golf or baseball, the visualization information generation unit visualizes the exercise with time-series information indicating a trajectory of a wrist of the user.
   (10)

The information processing device according to (3) described above, in which
in a case where the display mode is an overlay visualization display mode, the visualization information generation unit generates the exercise visualization image by overlaying a correct three-dimensional shape registered in advance on the three-dimensional shape of the user.
   (11)

The information processing device according to (3) described above, in which
in a case where the display mode is an exaggeration effect visualization display mode, the visualization information generation unit generates the exercise visualization image by arranging an effect to exaggerate an exercise of the user in accordance with the exercise.
   (12)

The information processing device according to (11) described above, in which
when the user performs a dance exercise, the visualization information generation unit visualizes the exercise using the effect to generate an air flow at a velocity corresponding to a speed of a motion of the user.
   (13)

The information processing device according to (11) described above, in which
when the user performs an exercise of throwing a ball, the visualization information generation unit visualizes the exercise using the effect to represent core balance of the user.
   (14)

The information processing device according to (11) described above, in which
when the user performs an exercise of pedaling bicycle-type fitness equipment, the visualization information generation unit visualizes the exercise using the effect to express wind blowing at a velocity corresponding to a speed at which the user pedals the bicycle-type fitness equipment.
   (15)

The information processing device according to (3) described above, in which
the visualization information generation unit generates the exercise visualization image by smoothly moving a position of the virtual camera when the display mode is switched.
   (16)

An information processing method including:
generating, by an information processing device, three-dimensional shape data representing a three-dimensional shape of a user on the basis of a depth image and an RGB image;
generating, by the information processing device, skeleton data representing a skeleton of the user on the basis of the depth image; and
generating, by the information processing device, visualization information for visualizing an exercise of the user using the three-dimensional shape data and the skeleton data, and arranging and capturing the visualization information on the three-dimensional shape of the user reconstructed in a virtual three-dimensional space on the basis of the three-dimensional shape data to generate an exercise visualization image.
   (17)

A program for causing a computer of an information processing device to execute information processing including:
generating three-dimensional shape data representing a three-dimensional shape of a user on the basis of a depth image and an RGB image;
generating skeleton data representing a skeleton of the user on the basis of the depth image; and
generating visualization information for visualizing an exercise of the user using the three-dimensional shape data and the skeleton data, and arranging and capturing the visualization information on the three-dimensional shape of the user reconstructed in a virtual three-dimensional space on the basis of the three-dimensional shape data to generate an exercise visualization image.

Note that the present embodiment is not limited to the above-described embodiment, and various modifications can be made without departing from the gist of the present disclosure. Furthermore, the effects described herein are merely examples and are not limited, and other effects may be provided.

### REFERENCE SIGNS LIST

11 Exercise visualization system
12 Sensor unit
13 Tablet terminal
14 Display device
15 Information processing device
41 Depth sensor
42 RGB sensor
51 Display
52 Touch panel
61 Sensor information integration unit
62 Three-dimensional shape generation unit
63 Skeleton detection unit
64 Object detection unit
65 UI information processing unit
66 Recording unit
67 Reproduction unit
68 Communication unit
71 Network
81 Projector

1. An information processing device comprising:
a three-dimensional shape generation unit that generates three-dimensional shape data representing a three-dimensional shape of a user on a basis of a depth image and an RGB image;
a skeleton detection unit that generates skeleton data representing a skeleton of the user on a basis of the depth image; and
a visualization information generation unit that generates visualization information for visualizing an exercise of the user using the three-dimensional shape data and the skeleton data, and arranges and captures the visualization information on the three-dimensional shape of the user reconstructed in a virtual three-dimensional space on a basis of the three-dimensional shape data to generate an exercise visualization image.

2. The information processing device according to claim 1, further comprising
an object detection unit that recognizes equipment used by the user on a basis of the depth image and the RGB image.

3. The information processing device according to claim 1, wherein
the visualization information generation unit generates the exercise visualization image by a virtual camera set in the virtual three-dimensional space in accordance with a plurality of display modes prepared in advance.

4. The information processing device according to claim 3, wherein
in a case where the display mode is a joint information visualization display mode, the visualization information generation unit generates the exercise visualization image by arranging, as the visualization information, joint information indicating an angle of a joint in a vicinity of the joint of the user reconstructed in the virtual three-dimensional space and setting the virtual camera to reflect the joint to be large.

5. The information processing device according to claim 1, wherein
when the user performs a squat exercise, the visualization information generation unit visualizes the exercise by joint information indicating an angle of a waist of the user.

6. The information processing device according to claim 1, wherein
when the user performs a kick exercise in soccer, the visualization information generation unit visualizes the exercise by joint information indicating an angle of a knee joint of the user.

7. The information processing device according to claim 1, wherein
when the user performs a punch exercise in boxing, the visualization information generation unit visualizes the exercise by joint information indicating an angle of a joint of an arm of the user.

8. The information processing device according to claim 3, wherein
in a case where the display mode is a time-series information visualization display mode, the visualization information generation unit sets the virtual camera to face vertically downward from directly above the user reconstructed in the virtual three-dimensional space, and generates the exercise visualization image in which past three-dimensional shapes of the user are displayed as the visualization information to flow at a predetermined interval and a trajectory linearly expressing a time course of a position of a head of the user is displayed as the visualization information.

9. The information processing device according to claim 1, wherein
when the user performs a swing exercise in golf or baseball, the visualization information generation unit visualizes the exercise with time-series information indicating a trajectory of a wrist of the user.

10. The information processing device according to claim 3, wherein
in a case where the display mode is an overlay visualization display mode, the visualization information generation unit generates the exercise visualization image by overlaying a correct three-dimensional shape registered in advance on the three-dimensional shape of the user.

11. The information processing device according to claim 3, wherein
in a case where the display mode is an exaggeration effect visualization display mode, the visualization information generation unit generates the exercise visualization image by arranging an effect to exaggerate an exercise of the user in accordance with the exercise.

12. The information processing device according to claim 11, wherein
when the user performs a dance exercise, the visualization information generation unit visualizes the exercise using the effect to generate an air flow at a velocity corresponding to a speed of a motion of the user.

13. The information processing device according to claim 11, wherein
when the user performs an exercise of throwing a ball, the visualization information generation unit visualizes the exercise using the effect to represent core balance of the user.

14. The information processing device according to claim 12, wherein
when the user performs an exercise of pedaling bicycle-type fitness equipment, the visualization information generation unit visualizes the exercise using the effect to express wind blowing at a velocity corresponding to a speed at which the user pedals the bicycle-type fitness equipment.

15. The information processing device according to claim 3, wherein
the visualization information generation unit generates the exercise visualization image by smoothly moving a position of the virtual camera when the display mode is switched.

16. An information processing method comprising:
generating, by an information processing device, three-dimensional shape data representing a three-dimensional shape of a user on a basis of a depth image and an RGB image;
generating, by the information processing device, skeleton data representing a skeleton of the user on a basis of the depth image; and
generating, by the information processing device, visualization information for visualizing an exercise of the user using the three-dimensional shape data and the skeleton data, and arranging and capturing the visualization information on the three-dimensional shape of the user reconstructed in a virtual three-dimensional space on a basis of the three-dimensional shape data to generate an exercise visualization image.

17. A program for causing a computer of an information processing device to execute information processing comprising:
generating three-dimensional shape data representing a three-dimensional shape of a user on a basis of a depth image and an RGB image;
generating skeleton data representing a skeleton of the user on a basis of the depth image; and
generating visualization information for visualizing an exercise of the user using the three-dimensional shape data and the skeleton data, and arranging and capturing the visualization information on the three-dimensional shape of the user reconstructed in a virtual three-dimensional space on a basis of the three-dimensional shape data to generate an exercise visualization image.
